(19) United States
(12) Patent Application Publication
(10) Pub. No.: US 2012/0249596 A1
(43) Pub. Date: Oct. 4, 2012

(54) METHODS AND APPARATUSES FOR DYNAMICALLY SCALING A TOUCH DISPLAY USER INTERFACE

(75) Inventor: Ashley Colley, Oulu (FI)

(73) Assignee: Nokia Corporation

(21) Appl. No.: 13/077,457

(22) Filed: Mar. 31, 2011

(51) Int. Cl. G09G 5/00

(52) U.S. Cl. 345/660

(57) ABSTRACT

Methods, apparatuses, and computer program products are herein provided for dynamically scaling a touch display user interface. Some embodiments provide a method, apparatus, and computer program product for monitoring a user's error rate and adapting the size of the on-screen virtual keyboard, or other touch display user interface, to compensate for the monitored error rate in an effort to obtain an acceptable error rate. A method may include receiving user input to a touch display user interface. The method may further include determining, by a processor, an error parameter that corresponds to the user input for the touch display user interface. The method may also include causing, based at least in part on the determined error parameter, a modification in size of the touch display user interface. Corresponding apparatuses and computer program products are also provided.

### TECHNOLOGICAL FIELD

Example embodiments of the present invention relate generally to user interface technology and, more particularly, relate to methods and apparatuses for dynamically scaling a touch display user interface.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Often, considering the small form factor, mobile computing devices incorporate screens that cover the entire visual surface. These screens may incorporate dynamic user interfaces for both content and touch display interaction. In particular, some computing devices may utilize at least a portion of the screen for touch display user-interfacing, such as an on-screen virtual keyboard. The remainder of the screen may be reserved for content display, such as for display of the text message being typed into the computing device. The desired functional capabilities of such virtual keyboards may require multiple keys, such as one key for each letter of the alphabet. Still more, some computing devices may include other keys, such as numbers or characters. The small space, due to the form factor, and the desire to reserve space for content display, limit the size of each key. The smaller individual key size may in turn lead to more user input errors when using the virtual keyboard.

### BRIEF SUMMARY

With increased functionality, content display is important for computing devices, including computing devices that utilize on-screen virtual keyboards or other touch display user interfaces. However, the direct proportional relationship between content display and touch display means that maximizing content display minimizes touch display dedicated to user input, thereby decreasing the size of the individual keys on the virtual keyboard. This decrease in individual key size can lead to more errors during user input. Additionally, many users are better than others at entering user input on touch display user interfaces. For example, some users may be more familiar with a particular screen or may use a more accurate pointing device (e.g., a stylus). Moreover, certain circumstances may create added difficulty with entering user input, such as faster typing, lack of concentration, or movement while typing (e.g., walking or sitting on a train).

As such, methods, apparatuses, and computer program products are herein provided for dynamically scaling a touch display user interface. Some embodiments provide a method, apparatus, and computer program product for monitoring a user's error rate and adapting the size of the on-screen virtual keyboard, or other touch display user interface, to compensate for the monitored error rate in an effort to obtain an acceptable error rate. These changes in size of the virtual keyboard may result in changes of each individual key, which can significantly affect the user's ability to accurately enter text or other input. As such, embodiments of the present invention provide a touch display user interface that adapts to a particular user or circumstance in an effort to produce an acceptable error rate while maximizing content display.

In one example embodiment, a method may include receiving user input to a touch display user interface. The method may further include determining, by a processor, an error parameter that corresponds to the user input for the touch display user interface. The method may also include causing, based at least in part on the determined error parameter, a modification in size of the touch display user interface. In another embodiment, the method may further include comparing, by a processor, the determined error parameter to an acceptable error parameter. Further, causing the modification of the touch display user interface may comprise causing modification in an instance which the determined error parameter is different than the acceptable error parameter.

In another example embodiment, an apparatus comprising at least one processor and at least one memory storing computer program code, wherein the at least one memory and stored computer program code are configured, with the at least one processor, to cause the apparatus to at least receive user input to a touch display user interface. The at least one memory and stored computer program code are configured, with the at least one processor, to further cause the apparatus of this example embodiment to determine an error parameter that corresponds to the user input for the touch display user interface. The at least one memory and stored computer program code are configured, with the at least one processor, to further cause the apparatus of this example embodiment to cause, based at least in part on the determined error parameter, a modification in size of the touch display user interface.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method comprising receiving user input to a touch display user interface. The computer program product of this example embodiment further comprises determining an error parameter that corresponds to the user input for the touch display user interface. The computer program product of this example embodiment additionally comprises causing, based at least in part on the determined error parameter, a modification in size of the touch display user interface.

In another example embodiment, an apparatus is provided. The apparatus comprises a means for receiving user input to a touch display user interface. The apparatus may also comprise a means for determining an error parameter that corresponds to the user input for the touch display user interface. The apparatus may further comprise a means for causing, based at least in part on the determined error parameter, a modification in size of the touch display user interface.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus that includes a touch display user interface according to an example embodiment;

FIG. 2 is a schematic block diagram of a mobile terminal according to an example embodiment;

FIGS. 3A-3C illustrate touch display user interfaces for an apparatus as shown in FIG. 1, wherein the touch displays are configured with different vertical scales, according to an example embodiment;

FIGS. 4A-4B illustrate touch display user interfaces for an apparatus as shown in FIG. 1, wherein the touch displays are configured with different horizontal scales, according to an example embodiment;

FIG. 5 illustrates a touch display user interface for an apparatus as shown in FIG. 1, wherein the touch display is configured to switch modes (e.g., keys) in response to user input in the form of a sliding motion, according to an example embodiment;

FIG. 6 illustrates a flowchart according to an example method for dynamically scaling a touch display user interface according to an example embodiment;

FIG. 7 illustrates a flowchart according to another example method for dynamically scaling a touch display user interface according to an example embodiment; and

FIG. 8 illustrates a flowchart according to another example method for dynamically scaling a touch display user interface according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

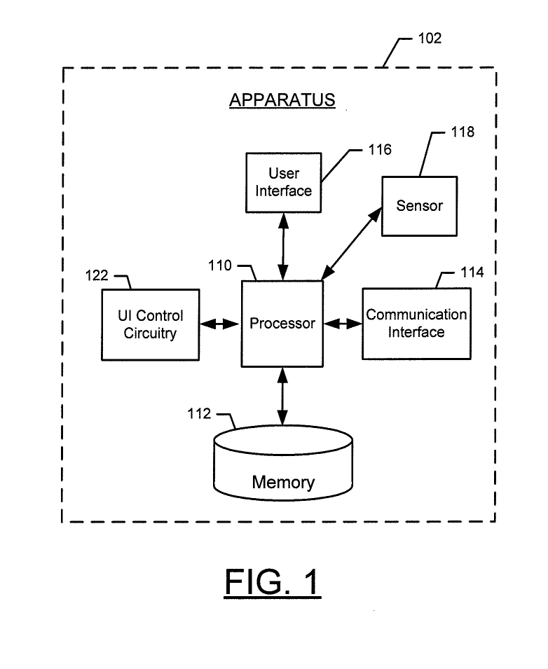

FIG. 1 illustrates a block diagram of an apparatus 102 for facilitating interaction with a user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

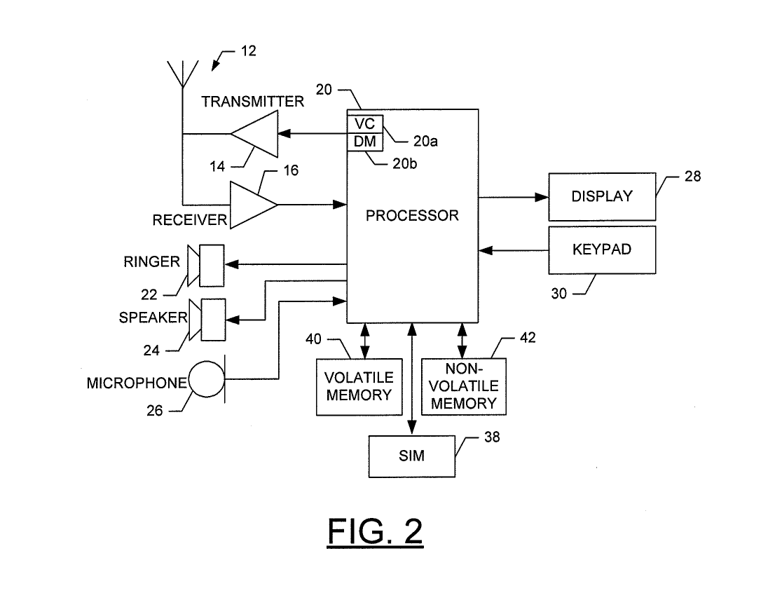

The apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

In some embodiments, the apparatus 102 may include a sensor 118 that is in communication with the processor 110. The sensor 118 may be configured to determine when the apparatus 102 is picked up, moved, or otherwise displaced. In some embodiments, the sensor 118 may be an accelerometer or similar device.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus. In some example embodiments, the user interface may comprise content display and touch display. In some embodiments, the user interface may comprise a touch display user interface with a content display portion and a dedicated user input portion, such as a virtual keyboard. In such embodiments, the content portion and the dedicated user input portion may be directly proportional, such that an increase in size of one portion causes a decrease in the size of the other portion. As used herein for embodiments of the present invention, a “touch display” or “touch display user interface” may refer to either the entire touch display user interface or just the portion dedicated to user input.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive a user input from a user interface 116, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine an element/instruction/command that corresponds with a key, or image, displayed on the touch display user interface at the determined position or within a predefined proximity (e.g., within a predefined tolerance range) of the determined position. The processor 110 may be further configured to perform a function or action related to the key corresponding to the element/instruction/command determined by the UI control circuitry 122 based on the position of the touch or other user input. A non-limiting example of this function or action includes displaying a letter on the content display screen of the user interface 116 of the apparatus 102, wherein the letter corresponds to a key at the determined position in which the user-input originated. Example embodiments are useful in performing functions such as typing an email or text message.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a projected capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

One difficulty of touch display user interfaces, such as virtual keyboards, includes limited space for each key or other interactive UI component. In particular, size of the touch display user interface is limited by the space available on the user interface 116 for the apparatus 102. Moreover, it is often desirable to limit the size of the touch display user interface to maximize the remainder of the user interface. For example, the remainder of the user interface (e.g., the content display) may include visual content provided to a user, such as a web page or a screen image of a text message.

Limited space for each key can lead to errors in user input, such as a user selecting a key other than the desired key. These errors can be further compounded through movement of the apparatus 102 (e.g., the apparatus is traveling on a train or subway). Moreover, some users may be more adept at selecting the desired key without accidentally selecting an undesired key. As such, touch display user interfaces that are capable of being differently sized may be advantageous since the size may be tailored for each user or circumstance. For example, a larger touch display user interface may be useful for user who otherwise suffers from more input errors on the smaller touch display user interface. However, if errors are less common, a smaller touch display user interface may be more desirable to maximize content display on the remainder of the user interface.

The processor 110 may be further configured to determine an error parameter that corresponds to the user input for the touch display user interface. The error parameter can be any statistic or variable related to user input errors and may be a specific number (e.g., 10 errors) or an error rate (e.g., 10 errors out of 100 words, or 500 characters). A specific number of errors may relate to a specific number that occur within a particular session—e.g. since a virtual keyboard was displayed, an application launched, or text-input activity began (e.g. focus was changed to a text box), and the specific number reset once that session has ended—e.g. the keyboard ceases to be displayed, the application is closed, or text-input activity ceases (e.g. focus is removed from the text box). The term “error rate” may be used herein for description purpose of example embodiments, however, it is understood that example embodiments may be configured to use of an error parameter. In some embodiments, the processor 110 may determine how many errors occur over a predetermined length of time (e.g., 1 hour, 1 day, 1 message, 10 words, etc.). In other embodiments, the processor 110 may determine how many errors occur over a predetermined number of user inputs (e.g. the number of characters or words entered by the user). In some embodiments, the processor 110 may be configured to continuously determine the error rate.

The processor 110 may be further configured to compare the determined error rate to a pre-determined acceptable error rate, or error parameter. An acceptable error rate may be configured based upon the specific apparatus, user, or circumstance, among other things. The acceptable error rate may be a range of error frequency, such as an error rate of a particular number of errors for a particular number of input actions (e.g. key presses), or for a particular number of words. For example, the acceptable error rate may be one error for every 20 words entered. In some embodiments that value the accuracy over the size of the content display, it may be beneficial to maintain a error rate substantially near zero, while in other embodiments in which accuracy is less important, it may be more beneficial to maintain a non-zero error rate to result in a smaller touch display and larger content display.

In some embodiments the acceptable error rate may be configured by the user, for example using an interactive UI component such as a slider that forms part of the keyboard. In some embodiments the acceptable error rate may be defined by the user via a settings menu. In other embodiments the acceptable error rate is defined by the device manufacturer, for example during the manufacturing process. In other embodiments the acceptable error rate is defined by the provider of a particular service or application, and may apply to only interactions which take place within that particular service or application. In some embodiments a particular acceptable error rate is assigned to a particular field within a user interface—for example to a particular text input field. In this way, a lower acceptable error rate may be assigned where accuracy is important (e.g. in a password field) and a higher acceptable error rate may be assigned when accuracy is less important (e.g. when typing a memorandum).

In some embodiments, the processor 110 may be configured to determine the error rate, or error parameter, through monitoring of an auto-correction engine and/or use of a delete key. The delete key may be a “backspace” key. For example, the processor 110 may be configured to monitor how often an auto-correction occurs to correct an error created by selection of an undesired key. Additionally, use of the “delete” key may be monitored to determine how often the user corrects an error that has occurred. In some embodiments, the processor 110 may be configured to use both the rate of correction from the auto-correction engine and the “delete” key to determine the error rate.

Where another specific function is provided to correct user inputs (e.g. words that have been entered using text input) the use of this function may be similarly monitored to determine the error rate.

The UI control circuitry 122 may be further configured to cause a modification of the touch display of the user interface 116. As an example, the UI control circuitry 122 may be configured to modify the size of the touch display, which may also modify the size of the corresponding keys in the touch display. In some embodiments, modification of the size of the touch display may also correspond with a modification in the size of the content display with modifications of the touch display and the content display being inversely proportional. Modification of the touch display user interface may also include removing, adding, or changing of keys for user input. In some embodiments, the UI control circuitry 122 may be configured to modify the scale of the touch display vertically, horizontally, and/or in any other direction. In some embodiments, modification of the touch display may depend on space available on the apparatus 102. For example, the touch display user interface may already span horizontally across the apparatus and the UI control circuitry 122 may be configured to modify the touch display vertically.

The UI control circuitry 122 may be further configured to modify the touch display user interface in response to the processor 110 determining a certain error rate. In some embodiments, the UI control circuitry 122 may modify the touch display user interface based at least in part on the determined error rate. In other embodiments, the UI control circuitry 122 may be configured to modify the touch display user interface when the processor 110 determines a difference between the determined error rate and the acceptable error rate. For example, when a determined error rate is greater than the acceptable error rate, the UI control circuitry 122 may be configured to increase the size of the touch display user interface, thereby increasing the size of each key in an effort to decrease the user's error rate. Likewise, when a determined error rate is less than the acceptable error rate, the UI control circuitry 122 may be configured to decrease the size of the touch display user interface, thereby decreasing the size of each key and increasing the size of the content display. In other embodiments, the UI control circuitry 122 may be configured to modify the touch display user interface in response to the processor 110 receiving a signal from the sensor 118, such as a signal that the apparatus 102 is moving.

Additionally or alternatively, the UI control circuitry 122 may be configured to automatically modify the touch display user interface based on a determined error rate. In some embodiments, modification can occur constantly, such as when the determined error rate differs from the acceptable error rate. In such embodiments, the acceptable error rate may determine when the UI control circuitry 122 enlarges, shrinks, or maintains the size of the touch display user interface. In other embodiments, the UI control circuitry 122 may be configured to modify the touch display user interface at specific times, such as when an event occurs or after a pre-determined period of time. In some embodiments, an event may be typing a new word, line, paragraph, or entire text entry. Moreover, in other embodiments, the event may be when the touch display user interface is initially displayed for user input (e.g., display of the virtual keyboard for typing). Such variations in when the modification may occur may be beneficial to avoid disruption in user input such as typing.

The UI control circuitry 122 may be further configured to modify the touch display to a certain degree or amount. In some embodiments, the processor 110 may determine the amount or degree in which the UI control circuitry 122 will modify the touch display. Moreover, the UI control circuitry 122 may be configured to modify the touch display to a degree or amount that depends on the severity of the error rate or difference between the error rate and the acceptable error rate. In some embodiments, the UI control circuitry 122 may also be configured to modify the touch display in steps or patterns. Additionally or alternatively, the UI control circuitry 122 may be configured to modify the touch display a fixed amount, such as a percentage of the current size of the touch display.

The UI control circuitry 122 may also be configured to modify the touch display user interface at different speeds. For example, in some embodiments, the touch display user interface may modify rapidly, such as when a user stands up or begins moving with the apparatus 102. Such movement, as noted above, may be determined with the sensor 118. In other embodiments, the modification may be slower and take place over an extended period of time, such as over hours, days, or longer. Such embodiments may be less disruptive, allowing the touch display user interface to gradually adapt to the habits of the user.

The UI control circuitry 122 may also be configured to modify the touch display user interface based on user input corresponding to a key that indicates modification should occur. In some embodiments, a key may indicate a desired increase or decrease in the size of the touch display user interface. The UI control circuitry 122 may be configured to correspondingly increase or decrease the size of the touch display user interface in response to receiving such an indication.

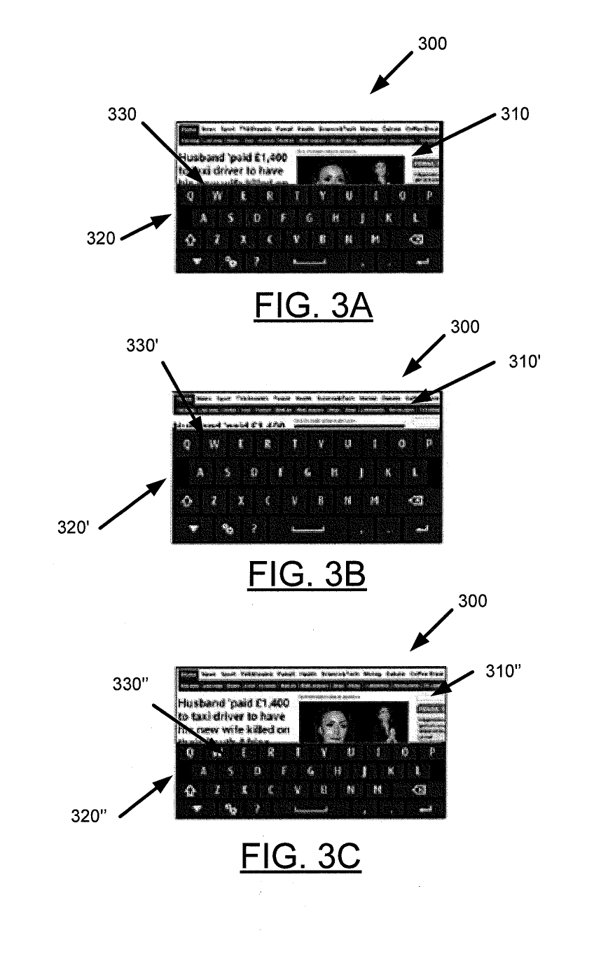

Referring now to FIGS. 3A-3C, FIGS. 3A-3C illustrate examples of vertical scalability for modification of a touch display user interface. In the depicted embodiments, an apparatus 300 comprises a user interface with a content display 310, 310′, 310″ and a touch display 320, 320′, 320″ (e.g., a virtual keyboard). Each touch display 320, 320′, 320″ may comprise individual keys 330, 330′, 330″ that correspond to an instruction, command, or indication based on a determined position on the touch display 320, 320′, 320″. With reference to FIG. 3A, a user may input commands/instructions by touching/poking a key 330 displayed on the touch display 320. However, as noted above, the small size of the key may cause an error to occur. For example, such an error may include the apparatus 300 receiving an indication that the “Q” was selected, when the user was attempting to select the “W”. As described herein, and illustrated in FIG. 3B, the touch display 320′ may be vertically enlarged so as to increase the area that corresponds to each individual key 330′, such as in an instance in which the error rate is high, such as greater than a pre-determined threshold. Enlarging each key 330′ will increase the likelihood that the correct key is selected by the user. Vertically enlarging the touch display 320′, however, also vertically shrinks the content display 310′, which may be undesirable. As shown in FIG. 3C, the touch display 320″ may alternatively be shrunk vertically to increase the size of the content display 310″, such as instances in which the error rate is low, such as lower than a pre-determined threshold. However, decreasing the touch display 320″, as noted above, also decreases the area that corresponds to each key 330″, increasing the likelihood of an error occurring. As such, embodiments of the present invention, may automatically increase or decrease the vertical scale of the touch display to obtain an acceptable error rate while allowing for the greatest space available for content display.

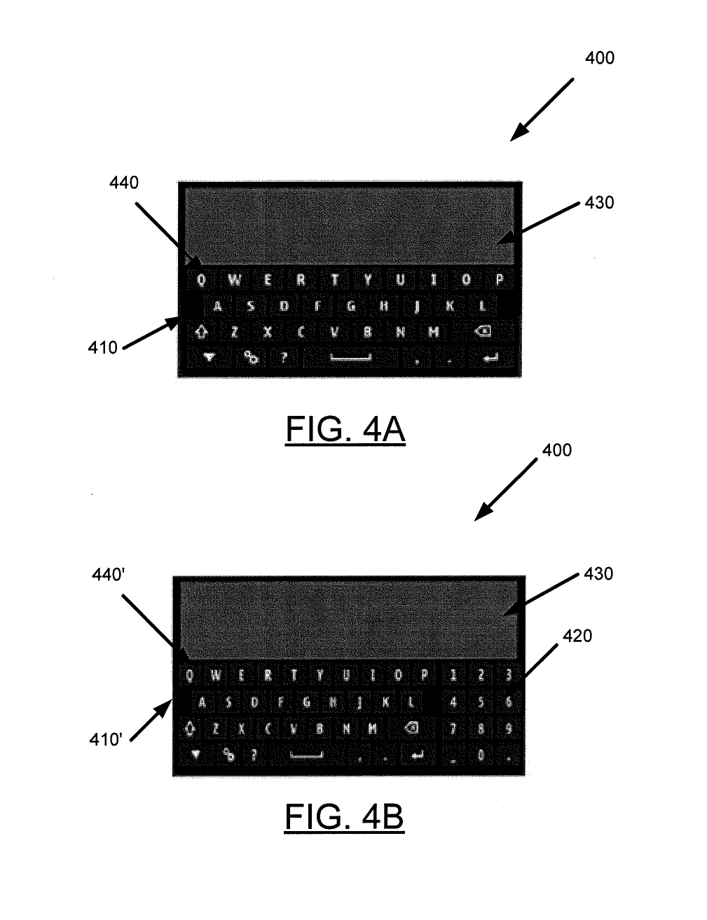

FIGS. 4A and 4B illustrate horizontal scalability of touch display user interfaces according to embodiments of the present invention. In the depicted embodiments, the apparatus 400 may comprise a content display 430 and a touch display 410, 410′ (e.g., a virtual keyboard). The touch display 410, 410′ may comprise individual keys 440, 440′. For some applications of the apparatus 400, it may be desirable to have quick access to certain keys, such as numbers. As such, some embodiments of the present invention allow for horizontal scalability of the touch display 410, 410′. For example, as illustrated in FIG. 4B, the touch display 410′ may be modified for the addition of new keys 420 that may correspond to new numbers or other characters. In such embodiments, the content display 430 may stay the same size as before (shown in FIG. 4A), but the keys 440′ may shrink to accommodate the addition of the new keys 420.

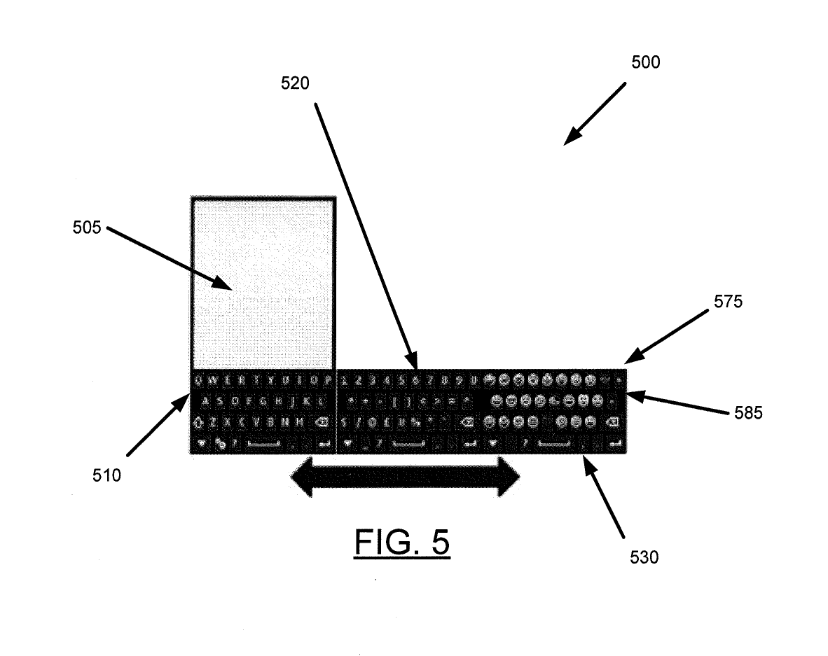

FIG. 5 illustrates an example of an apparatus with the capability of switching touch display user interface upon user input in the form of a sliding motion. In the depicted embodiment, an apparatus 500 may comprise a user interface with a content display 505 and a touch display 510, 520, 530 (e.g., a virtual keyboard). The number of keys desired for user input has increased and, so to avoid greatly decreasing the area corresponding to each individual key, embodiments of the present invention include separating keys into different touch displays 510, 520, 530. In some embodiments, the apparatus 500 may be configured to change the types of keys in the touch display upon an indication by a user. In some embodiments, a user may initiate a slide (e.g., sweep their finger across the touch display) to cause the touch display to change keys. For example, a user may slide from a touch display 510 with letters to a touch display 520 with numbers or even to a touch display 530 with smiley faces or other emoticons.

FIG. 5 also illustrates example embodiments that allow for user initiated modification of the size of the touch display. In the depicted embodiment, the touch display 530 comprises a “+” key 575 and “−” key 585. The “+” key 575 may be configured to indicate to the apparatus 500 to increase the size of the touch display 510, 520, 530. The “−” key 585 may be configured to indicate to the apparatus 500 to decrease the size of the touch display 510, 520, 530. In such embodiments, a user can self-configure the touch display by directly causing a size modification of the touch display.

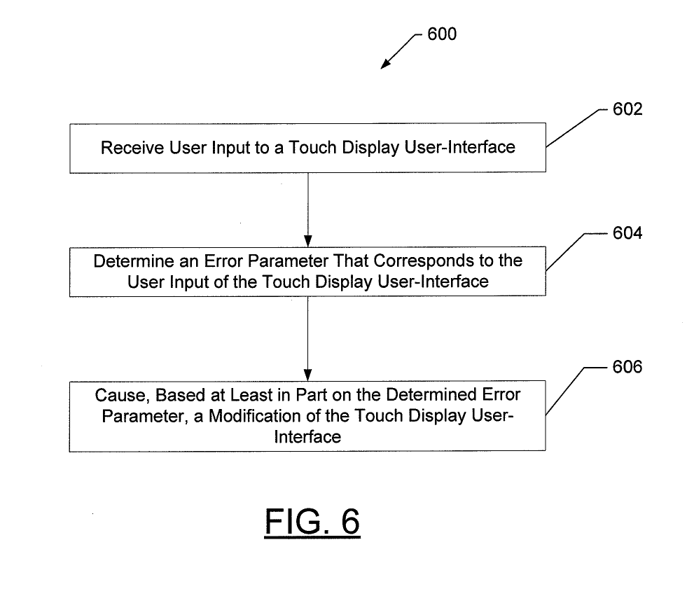

FIG. 6 illustrates a flowchart according to an example method for dynamically scaling a touch display user interface according to an example embodiment 600. The operations illustrated in and described with respect to FIG. 6 may, for example, be performed by, with the assistance of, and/or under the control of one or more of the processor 110, memory 112, communication interface 114, user interface 116, or UI control circuitry 122. Operation 602 may comprise receiving user input to a touch display user interface (e.g., a virtual keyboard). The processor 110, memory 112, user interface 116, and/or UI control circuitry 122 may, for example, provide means for performing operation 602. Operation 604 may comprise determining an error parameter that corresponds to the user input of the touch display user interface. The processor 110, memory 112, user interface 116, and/or UI control circuitry 122 may, for example, provide means for performing operation 604. Operation 606 may comprise causing, based at least in part on the determined error parameter, a modification of the touch display user interface. The processor 110, memory 112, user interface 116, and/or UI control circuitry 122 may, for example, provide means for performing operation 606. In some embodiments, the method 600 may comprise causing modification in the size of the touch display user interface. Moreover, some embodiments may comprise causing modification of the touch display user interface in an instance which an event occurs, wherein such event may include initiating display of the touch display user interface. Furthermore, some embodiments may comprise determining the error parameter over a pre-determined length of time and/or number of user inputs. The processor 110, memory 112, user interface 116, and/or UI control circuitry 122 may, for example, provide means for performing these operations.

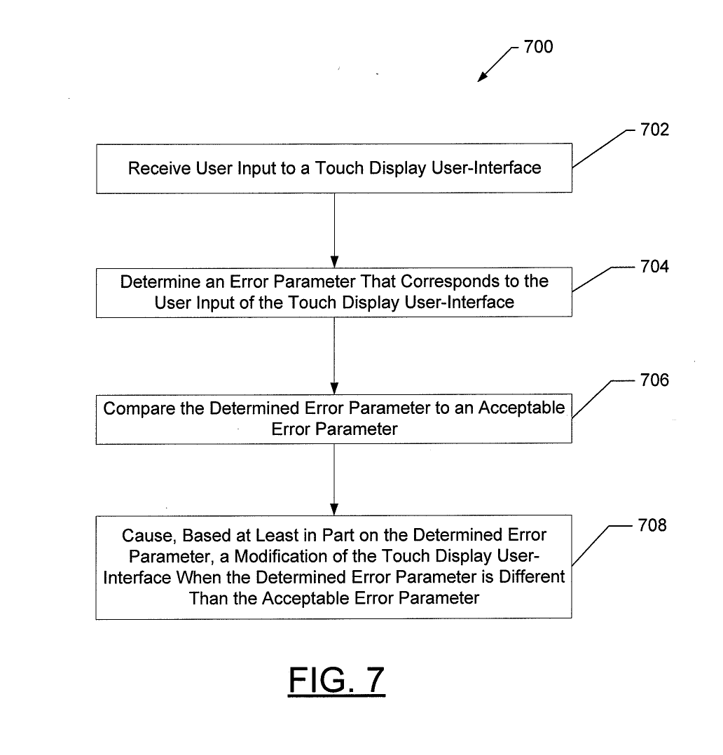

FIG. 7 illustrates a flowchart according to an example method for dynamically scaling a touch display user interface according to an example embodiment 700. The operations illustrated in and described with respect to FIG. 7 may, for example, be performed by, with the assistance of, and/or under the control of one or more of the processor 110, memory 112, communication interface 114, user interface 116, or UI control circuitry 122. Operation 702 may comprise receiving user input to a touch display user interface. The processor 110, memory 112, user interface 116, and/or UI control circuitry 122 may, for example, provide means for performing operation 702. Operation 704 may comprise determining an error parameter that corresponds to the user input of the touch display user interface. The processor 110, memory 112, user interface 116, and/or UI control circuitry 122 may, for example, provide means for performing operation 704. Operation 706 may comprise comparing the determined error parameter to an acceptable error parameter. The processor 110, memory 112, user interface 116, and/or UI control circuitry 122 may, for example, provide means for performing operation 706. Operation 708 may comprise causing, based at least in part on the determined error parameter, a modification of the touch display user interface in an instance which the determined error parameter is different than the acceptable error parameter. The processor 110, memory 112, user interface 116, and/or UI control circuitry 122 may, for example, provide means for performing operation 708. In some embodiments, the method 700 may comprise causing modification further based at least in part on the comparison of the determined error parameter to the acceptable error parameter. Moreover, some embodiments may comprise causing modification by increasing the size of the touch display user interface in an instance which the determined error parameter is greater than the acceptable error parameter. Furthermore, some embodiments may comprise causing modification by decreasing the size of the touch display user interface in an instance which the determined error parameter is less than the acceptable error parameter. The processor 110, memory 112, user interface 116, and/or UI control circuitry 122 may, for example, provide means for performing these operations.

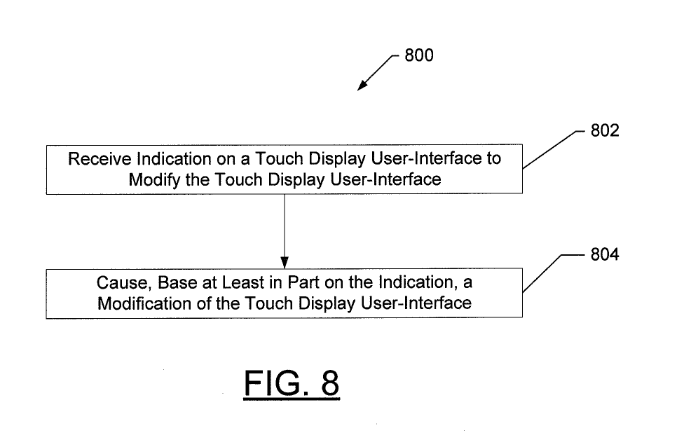

FIG. 8 illustrates a flowchart according to an example method for dynamically scaling a touch display user interface according to an example embodiment 800. The operations illustrated in and described with respect to FIG. 8 may, for example, be performed by, with the assistance of, and/or under the control of one or more of the processor 110, memory 112, communication interface 114, user interface 116, or UI control circuitry 122. Operation 802 may comprise receiving an indication on a touch display user interface to modify the touch display user interface. The processor 110, memory 112, user interface 116, and/or UI control circuitry 122 may, for example, provide means for performing operation 802. Operation 804 may comprise causing, based at least in part on the indication, a modification of the touch display user interface. The processor 110, memory 112, user interface 116, and/or UI control circuitry 122 may, for example, provide means for performing operation 804. In some embodiments, the method 800 may comprise causing modification in the size of the touch display user interface. The processor 110, memory 112, user interface 116, and/or UI control circuitry 122 may, for example, provide means for performing these operations.

FIGS. 6-8 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving user input to a touch display user interface;
determining, by a processor, an error parameter that corresponds to the user input for the touch display user interface; and
causing, based at least in part on the determined error parameter, a modification in size of the touch display user interface.

2. The method of claim 1, further comprising comparing, by a processor, the determined error parameter to an acceptable error parameter, and wherein causing the modification of the touch display user interface comprises causing modification in an instance which the determined error parameter is different than the acceptable error parameter.

3. The method of claim 2, wherein causing modification of the touch display user interface comprises causing modification further based at least in part on the comparison of the determined error parameter to the acceptable error parameter.

4. The method of claim 2, wherein causing modification of the touch display user interface comprises increasing the size of the touch display user interface in an instance which the determined error parameter is greater than the acceptable error parameter.

5. The method of claim 2, wherein causing modification of the touch display user interface comprises decreasing the size of the touch display user interface in an instance which the determined error parameter is less than the acceptable error parameter.

6. The method of claim 1, wherein causing modification of the touch display user interface comprises causing modification in an instance which an event occurs.

7. The method of claim 1, wherein determining the error parameter comprises determining the error parameter over a pre-determined length of time.

8. An apparatus comprising at least one processor and at least one memory storing computer program code, wherein the at least one memory and stored computer program code are configured, with the at least one processor, to cause the apparatus to at least:
receive user input to a touch display user interface;
determine an error parameter that corresponds to the user input for the touch display user interface; and
cause, based at least in part on the determined error parameter, a modification in size of the touch display user interface.

9. The apparatus of claim 8, wherein the at least one memory and stored computer program code are configured, with the at least one processor, to cause the apparatus to:
compare the determined error parameter to an acceptable error parameter; and
cause modification of the touch display user interface in an instance which the determined error parameter is different than the acceptable error parameter.

10. The apparatus of claim 9, wherein the at least one memory and stored computer program code are configured, with the at least one processor, to cause the apparatus to:
cause modification of the touch display user interface further based at least in part on the comparison of the determined error parameter to the acceptable error parameter.

11. The apparatus of claim 9, wherein the at least one memory and stored computer program code are configured, with the at least one processor, to cause the apparatus to:
cause modification of the touch display user interface by increasing the size of the touch display user interface in an instance which the determined error parameter is greater than the acceptable error parameter.

12. The apparatus of claim 9, wherein the at least one memory and stored computer program code are configured, with the at least one processor, to cause the apparatus to:
cause modification of the touch display user interface by decreasing the size of the touch display user interface in an instance which the determined error parameter is less than the acceptable error parameter.

13. The apparatus of claim 8, wherein the at least one memory and stored computer program code are configured, with the at least one processor, to cause the apparatus to:
cause modification of the touch display user interface in an instance which an event occurs.

14. The apparatus of claim 8, wherein the at least one memory and stored computer program code are configured, with the at least one processor, to cause the apparatus to:
determine the error parameter over a pre-determined length of time.

15. A computer program product comprising at least one non-transitory computer-readable storage medium having computer-readable program instructions stored therein, the computer-readable program instructions comprising program instructions configured to cause an apparatus to perform a method comprising:
receiving user input to a touch display user interface;
determining an error parameter that corresponds to the user input for the touch display user interface; and
causing, based at least in part on the determined error parameter, a modification in size of the touch display user interface.

16. The computer program product of claim 15, wherein the method further comprises:
comparing, by a processor, the determined error parameter to an acceptable error parameter, wherein causing the modification of the touch display user interface comprises causing modification in an instance which the determined error parameter is different than the acceptable error parameter.

17. The computer program product of claim 16, wherein:
causing modification of the touch display user interface comprises causing modification further based at least in part on the comparison of the determined error parameter to the acceptable error parameter.

18. The computer program product of claim 16, wherein:
causing modification of the touch display user interface comprises increasing the size of the touch display user interface in an instance which the determined error parameter is greater than the acceptable error parameter.

19. The computer program product of claim 15, wherein:
causing modification of the touch display user interface comprises causing modification in an instance which an event occurs.

20. The computer program product of claim 15, wherein:
determining the error parameter comprises determining the error parameter over a pre-determined length of time.
